(19) United States
(12) Patent Application Publication
(10) Pub. No.: US 2005/0061576 A1
(43) Pub. Date: Mar. 24, 2005

(54) Variable gear-ratio mechanism and steering control system using same

(75) Inventors: Toshiaki Nakamura, Kanagawa (JP); Satoshi Taniuchi, Kanagawa (JP); Kohtaro Shiino, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: HITACHI UNISIA AUTOMOTIVE, LTD.

(21) Appl. No.: 10/941,832

(22) Filed: Sep. 16, 2004

(30) Foreign Application Priority Data
Sep. 24, 2003 (JP) 2003-332331

(51) Int. Cl. B62D 5/04

(52) U.S. Cl. 180/444

(57) ABSTRACT

A variable gear-ratio mechanism includes a rotary element for connecting input and output shafts and having rotation and revolution components. The rotation component is formed with an axial through hole. The input and output shafts are engaged to be rotatable relatively, and the input or output shaft is arranged through the axial through hole.

### BACKGROUND OF THE INVENTION

The present invention relates to a variable gear-ratio mechanism, and more particularly, to the variable gear-ratio mechanism which can vary the amount of steering angle with respect to driver's steering operation in accordance with the vehicle cruising conditions.

One of the typical variable gear-ratio mechanisms is disclosed in German document DE 10160313 A1. This variable gear-ratio mechanism comprises internal gears of different diameters connected to input and output shafts, external gears of different diameters meshed with the internal gears, and a rotation shaft fixed to the external gears. The rotation shaft is supported on a worm wheel to be offset with respect to the input and output shafts. Control is effected to a worm shaft meshed with the worm wheel to control revolution of the external gears, achieving control of the relative rotation amount produced between the input and output shafts.

### SUMMARY OF THE INVENTION

With the variable gear-ratio mechanism disclosed in German document DE 10160313 A1, however, since the input and output shafts are not connected to each other, they provide lower stiffness therebetween.

It is, therefore, an object of the present invention to provide a variable gear-ratio mechanism which contributes to enhanced stiffness between the input and output shafts. Another object of the present invention is to provide a steering control system using such variable gear-ratio mechanism.

The present invention provides generally a variable gear-ratio mechanism, which comprises: input and output shafts; and a rotary element which connects the input and output shafts, the rotary element comprising rotation and revolution components, wherein the rotation component is formed with an axial through hole, the input and output shafts being engaged to be rotatable relatively, one of the input and output shafts being arranged through the axial through hole.

### BRIEF DESCRIPTION OF THE DRAWINGS

The other objects and features of the present invention will become apparent from the following description with reference to the accompanying drawings, wherein:

FIG. 1 is a block diagram showing a first embodiment of a steering control system according to the present invention;

FIG. 2 is an enlarged sectional view showing a variable gear-ratio mechanism in the steering control system;

FIGS. 3A and 3B are sectional views taken along the line 3A-3A and the line 3B-3B in FIG. 2, respectively;

FIG. 4 is a schematic view showing the variable gear-ratio mechanism;

FIG. 5 is an alignment chart of the variable gear-ratio mechanism; and

FIG. 6 is a view similar to FIG. 2, showing a second embodiment of the present invention.

### DETAILED DESCRIPTION OF THE INVENTION

Referring to the drawings, a description will be made about preferred embodiments of a steering control system using a variable gear-ratio mechanism.

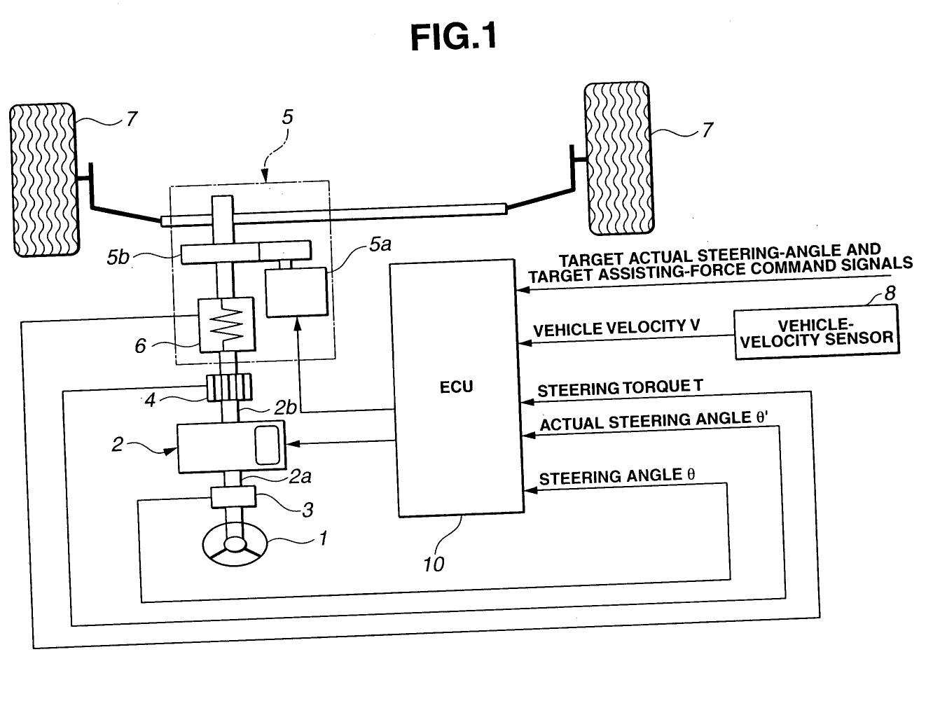

Referring to FIG. 1, there is shown first embodiment of the present invention. The steering control system comprises a steering shaft including upper and lower shafts 2a, 2b and a variable gear-ratio mechanism 2 arranged between upper and lower shafts 2a, 2b. A steering-angle sensor 3 is provided to upper shaft 2a to sense a steering angle θ produced by a driver. A torque sensor 6 is provided to lower shaft 2b to sense a steering torque T produced by the driver. An actual steering-angle sensor 4 is also provided to lower shaft 2b to sense an actual steering angle θ′ output from variable gear-ratio mechanism 2.

A power steering mechanism 5 serves to transmit rotation of an electric motor 5a to a reduction gear 5b provided to lower shaft 2b. When the driver operates a steering wheel 1, electric motor 5a is changed in direction of rotation in accordance with the direction of operation of steering wheel 1, assisting a driver's steering force to turn steered wheels 7.

An electronic control unit (ECU) 10 inputs various signals such as signal of steering torque T from torque sensor 6, signal of vehicle velocity V from a vehicle-velocity sensor 8, signal of driver's steering angle θ, and signal of actual steering angle θ′ from actual steering-angle sensor 4. In accordance with the input signals, ECU 10 outputs command signals to variable gear-ratio mechanism 2 and electric motor 5a.

There is no particular limitation about setting of the gear ratio made by variable gear-ratio mechanism 2. Typically, the gear ratio is set in accordance with the reference gear-ratio characteristics wherein the gradient of steered wheels 7 is set with respect to the steering angle of steering wheel 1.

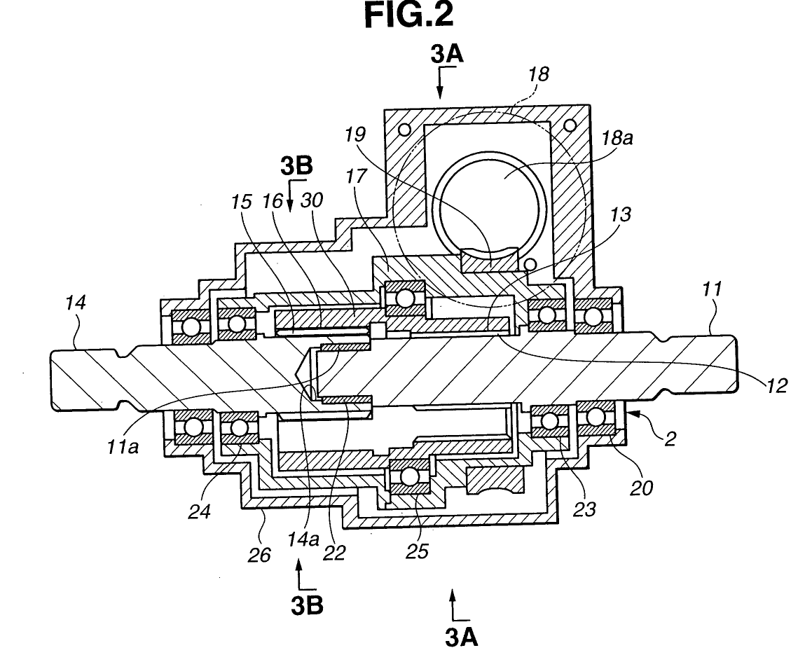

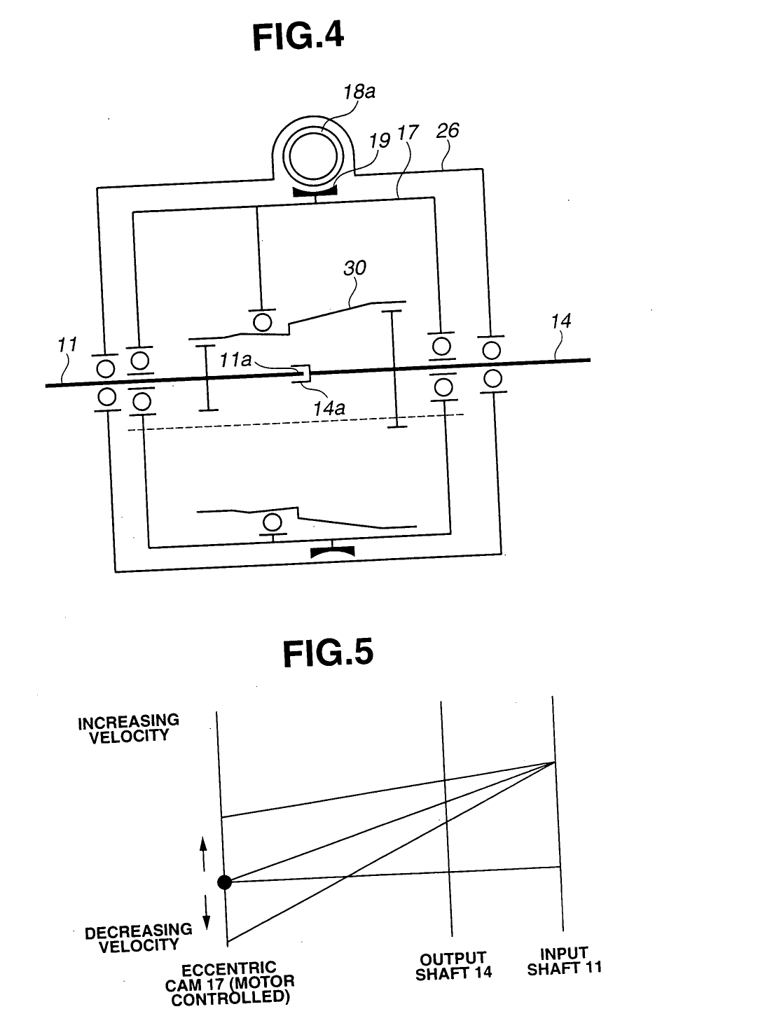

Referring to FIGS. 2 and 4, variable gear-ratio mechanism 2 comprises an input shaft 11 connected to upper shaft 2a, an output shaft 14 connected to lower shaft 2b, and a casing 26 including a bearing 20 for supporting input shaft 11, a bearing 24 for supporting output shaft 14, and a variable gear-ratio motor 18 for controlling the gear ratio.

A first external gear 12 is arranged on the outer periphery of input shaft 11, and an engagement 11a is arranged at an output-shaft side end thereof. A second external gear 15 is arranged on the outer periphery of output shaft 14, and an engagement hole 14a is arranged at an input-shaft side end thereof. A bearing 22 is arranged between engagement 11a and engagement hole 14a to smoothly support input and output shafts 11, 14 through their engagement so as to be rotatable relatively.

An eccentric cam 17 is supported on input and output shafts 11, 14 through bearings 23, 24. The center of rotation of eccentric cam 17 coincides with that of input and output shafts 11, 14. A worm wheel or control gear 19 is arranged on the outer periphery of eccentric cam 17 to control therethrough rotation of eccentric cam 17 by driving of worm shaft 18a connected to variable-gear ratio motor 18. Such integration of eccentric cam 17 and worm wheel 19 contributes to a size reduction of the system due to no need of additional arrangement of a bearing for worm wheel 19.

Moreover, the use of worm wheel 19 and worm shaft 18a allows achievement of the reduction ratio, resulting in a reduction in required torque of variable gear-ratio motor 18. When the worm wheel and worm gear are of the irreversible type, a braking force for eccentric cam 17 can be obtained during ordinary steering operation with no gear ratio changed, resulting in a reduction in electric power consumption.

Supported on the inner periphery of eccentric cam 17 through a bearing 25 is an internal gear 30 comprising a first internal gear 13 meshed with first external gear 12 and a second internal gear 16 meshed with second external gear 15.

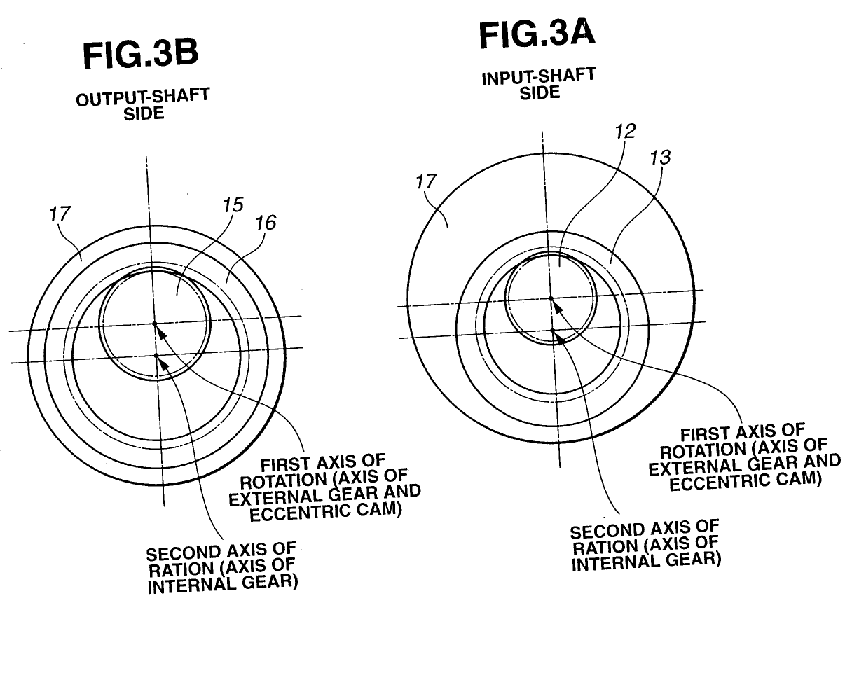

Referring to FIGS. 3A and 3B, input and output shafts 11, 14 and eccentric cam 17 have a first axis of rotation in common. On the other hand, internal gear 30 (first and second internal gears 13, 16) has a second axis of rotation offset with respect to the first axis of rotation. That is, the second axis of rotation is involved in the first axis of rotation in such a way as to revolve thereabout.

Referring to FIG. 5, a revolution component of internal gear 30 is controlled by rotation of variable gear-ratio motor 18. When variable gear-ratio motor 18 stops, rotation of input shaft 11 is reduced by the fundamental gear ratio (which depends on the gear radius) and transmitted to output shaft 14. When driving variable gear-ratio motor 18 in the same direction of rotation as that of input shaft 11, rotation of input shaft 11 on the increasing velocity side with respect to the fundamental gear ratio is transmitted to output shaft 14. On the other hand, when driving variable gear-ratio motor 18 in the opposite direction to that of input shaft 11, rotation on the decreasing velocity side with respect to the fundamental gear ratio is transmitted to output shaft 14.

As described above, in the first embodiment, when input and output shafts 11, 14 are connected through the rotary element having rotation and revolution components, a through hole is formed in the rotation component of internal gear 30 to support therethrough input and output shafts 11, 14 so as to be rotatable relatively. This allows an enhancement in stiffness between input and output shafts 11, 14. Further, when applying variable gear-ratio mechanism 2 to the steering control system, steering feel with high stiffness can be achieved. Furthermore, the external gears are provided to input and output shafts 11, 14, allowing a size reduction of the system.

In the first embodiment, input and output shafts 11, 14 are provided with external gears and connected through internal gear 30. However, the specific structure is not limited thereto, and may be replaced with an alternative wherein the through hole of the rotation component is formed to be greater than the revolution radius of the revolution component to support therethrough the input and output shafts so as to be rotatable relatively.

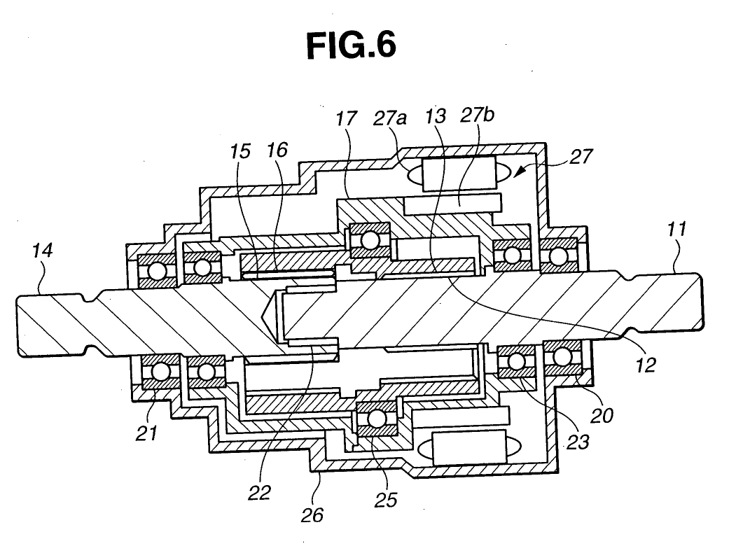

Referring to FIG. 6, there is shown second embodiment of the present invention which is substantially the same as the first embodiment. In the first embodiment, worm wheel 19 is arranged on the outer periphery of eccentric cam 17, whereas, in the second embodiment, a hollow motor 27 having in the center a through hole is arranged thereon. The hollow motor 27 comprises a stator coil 27a and a rotor 27b. Since input shaft 11 or output shaft 14 is disposed through the through hole of hollow motor 27, eccentric cam 17 can have restrained projection toward the radially outside of the gear-ratio controller such as variable gear-ratio motor 18, resulting in further size reduction of the system.

As described above, according to the present invention, since the input and output shafts can be supported to each other through their engagement, resulting in enhanced stiffness therebetween.

Further, since the input and output shafts are engaged to be rotatable relatively, allowing preservation of high stiffness therebetween.

Still further, since a bearing is arranged between the input and output shafts, smooth relative rotation of the two can be obtained with stiffness therebetween being preserved.

Still further, since the worm wheel as a third external gear is integrated with the first and second internal gears, the gear-ratio controller can be constructed without any additional arrangement of a bearing for the third external gear.

Furthermore, the reduction gear ratio between the worm gear and the worm shaft allows a reduction in required torque of the electric motor.

Further, since the input or output shaft is arranged through the though hole of the hollow motor, resulting in restrained projection toward the radially outside of the gear-ratio mechanism.

Furthermore, when applying the variable gear-ratio mechanism to the steering control system, the steering control system can provide steering feel with high stiffness.

Having described the present invention in connection with the preferred embodiments, it is noted that the present invention is not limited thereto, and various changes and modifications can be made without departing from the scope of the present invention.

The entire contents of Japanese Patent Application P2003-332331 filed Sep. 24, 2003 are hereby incorporated by reference.

1. A variable gear-ratio mechanism, comprising:
input and output shafts; and
a rotary element which connects the input and output shafts, the rotary element comprising rotation and revolution components, the rotation component being formed with an axial through hole,
the input and output shafts being engaged to be rotatable relatively,
one of the input and output shafts being arranged through the axial through hole.

2. A variable gear-ratio mechanism, comprising:
an input shaft;
a first external gear coaxially connected to the input shaft;
a first internal gear eccentrically meshed with the first external gear;
a second internal gear connected to the first internal gear;
a second external gear eccentrically meshed with the second internal gear;
an output shaft coaxially connected to the second external gear; and
a gear-ratio controller which controls rotation of the first and second internal gears in their entirety,
the first and second internal gears being formed with respective axial through holes,
the input and output shafts being engaged to be rotatable relatively,
at least one of the input and output shafts being arranged through the axial through holes.

3. The variable gear-ratio mechanism as claimed in claim 2, further comprising a bearing arranged between the input and output shafts.

4. The variable gear-ratio mechanism as claimed in claim 2, wherein the gear-ratio controller comprises a third external gear arranged coaxial with the input and output shafts and provided to one of the first and second internal gears, a control gear meshed with the third external gear, and an electric motor which controls the control gear.

5. The variable gear-ratio mechanism as claimed in claim 4, wherein the third external gear and the control gear comprises a worm gear and a worm shaft.

6. The variable gear-ratio mechanism as claimed in claim 2, wherein the gear-ratio controller comprises a hollow motor having in the center a through hole, wherein at least one of the input and output shafts is arranged through the though hole of the hollow motor.

7. A steering control system, comprising:
an input shaft connected to a steering input device;
a first steering-angle sensor which senses a steering angle of the input shaft;
an output shaft connected to steered wheels;
a second steering-angle sensor which senses an amount of a steering angle of the steered wheels;
an actuator which provides a steering force to the steered wheels;
an electronic control unit (ECU) which controls the actuator in accordance with the sensed steering angle and the sensed amount of the steering angle;
a variable gear-ratio mechanism arranged between the input and output shafts; and
a gear-ratio controller which controls a gear ratio of the variable gear-ratio mechanism in accordance with an amount of a steering angle input to the steering input device and the sensed amount of the steering angle,
wherein the variable gear-ratio mechanism comprises:
a first external gear coaxially connected to the input shaft;
a first internal gear eccentrically meshed with the first external gear;
a second internal gear connected to the first internal gear;
a second external gear eccentrically meshed with the second internal gear and coaxially connected to the output shaft; and
a gear-ratio controller which controls rotation of the first and second internal gears in their entirety,
the first and second internal gears being formed with respective axial through holes,
the input and output shafts being engaged to be rotatable relatively,
one of the input and output shafts being arranged through the axial through holes.

8. The steering control system as claimed in claim 7, further comprising a bearing arranged between the input and output shafts.

9. The steering control system as claimed in claim 7, wherein the gear-ratio controller comprises a third external gear arranged coaxial with the input and output shafts and provided to one of the first and second internal gears, a control gear meshed with the third external gear, and an electric motor which controls the control gear.

10. The steering control system as claimed in claim 9, wherein the third external gear and the control gear comprises a worm gear and a worm shaft.

11. The steering control system as claimed in claim 7, wherein the gear-ratio controller comprises a hollow motor having in the center a through hole, wherein one of the input and output shafts is arranged through the though hole of the hollow motor.
